(19) United States
(12) Patent Application Publication
(10) Pub. No.: US 2025/0286496 A1
(43) Pub. Date: Sep. 11, 2025

(54) Implementation of Sustainable Solar Energy Harvesting for Low-Cost Remote Sensors Equipped with Real-Time Monitoring Systems

(71) Applicant: UNM Rainforest Innovations, Albuquerque, NM (US)

(72) Inventors: Fernando Moreu, Albuquerque, NM (US); Solomon Atcitty, Albuquerque, NM (US); Joshua Murillo, Albuquerque, NM (US); Ali Khorasani, Albuquerque, NM (US); Kaveh Malek, Albuquerque, NM (US); Ali Ozdagli, Albuquerque, NM (US); Mahsa Sanei, Albuquerque, NM (US); Marlan Ball, Albuquerque, NM (US)

(73) Assignee: UNM Rainforest Innovations, Albuquerque, NM (US)

(21) Appl. No.: 18/892,316

(22) Filed: Sep. 20, 2024

Related U.S. Application Data
(60) Provisional application No. 63/584,163, filed on Sep. 20, 2023.
(60) Provisional application No. 63/584,164, filed on Sep. 20, 2023.

(51) Int. Cl. H02S 10/20; G01D 21/00; H04W 4/38

(52) U.S. Cl. CPC H02S 10/20; G01D 21/00; H04W 4/38

(57) ABSTRACT

A Wireless Smart Sensor Networks (WSSNs) data acquisition system that increases the resilience of infrastructure by providing real-time monitoring and data collection of environmental parameters.

### RELATED APPLICATIONS

This application claims priority to U.S. Provisional Application Nos. 63/584,163 and 63/584,164 both filed on Sep. 20, 2023, which are both incorporated herein in their entirety.

### STATEMENT REGARDING FEDERALLY SPONSORED RESEARCH & DEVELOPMENT

This invention was made with government support by the National Science Foundation Grant Nos. 2123346 and 2133334 and the Office of Naval Research, Grant No. N00014-21-1-2169. The government has certain rights in the invention.

### BACKGROUND OF THE INVENTION

Wireless Smart Sensor Networks (WSSNs) can be grouped under the intelligent methods for ensuring resilience of infrastructure because of the employment of advanced technologies such as wireless transmissions, sensing, and data analytics to enhance the resiliency of critical infrastructure. WSSNs can provide real-time data on the health and performance of various components of infrastructure, enabling proactive maintenance and reducing downtime. Real-time data acquisition via multifunctional sensor nodes and wireless networks is made possible by recent technological advancements in digital electronics, wireless technologies, and the expansion of internet connectivity.

Energy consumption is a significant design factor which influences the lifespan of low-cost self-made WSSNs and the amount of data they collect in outdoor applications, especially in remote locations. Two sustainable resources for powering sensor nodes are transferred energy and renewable energy. Transferred energy research includes, but is not limited to, inductive coupling, laser, and acoustic emission. On the other hand, renewable energy studies have focused on wind, piezoelectric conversion of environmental energy, and solar energy. Solar energy studies constitute most research on the renewable power generation for WSSNs. Several studies conducted numerical or analytical simulation to evaluate the level of boost in WSSN lifetime when the sensors are equipped with a solar system. While these simulation-based approaches provide valuable insights, experimental investigations are crucial for understanding the true impact of implementing solar energy systems in WSSNs. Table 1 summarizes several aspects presented in the experimental efforts shown in the first column. The processors and type of sensors are shown in the second and third columns, respectively. The deployment locations encompass remote areas, work sites, urban settings, solar power plants, and indoor labs (fourth column).

TABLE 1
Several aspects of experimental studies on solar-powered WSSN.

| | | | | | | Sensors# | |
|---|---|---|---|---|---|---|---|
| | | | Deployment | | | Analyzed in | Solar-Powered |
| Ref. | Processor | Sensor Type | Location | Period | | the Study | Communication |
| Dutta et al. | MSP430 | NM | Remote | Less than | | 557 | Solar-powered |
| (2006) | | | location | 1 day | | | gateway |
| Corke et al. | At-mega | NM | Work site | 365 | days | 1 | No |
| (2007) | 128 | | | | | | |
| Barrenetxea et | MSP430 | Wind | Remote | 30 | days | 18 | No |
| al. (2008) | | speed/direction | location | | | | |
| Dehwah et al., | Libelium | NM | Urban setting | 14 | days | 4 | No |
| (2015) | Waspmote | | | | | | |
| Ma et al. | ACS300- | Wind | Solar power | 1 | day | 1 | Solar-powered |

| | | | | | | |
|---|---|---|---|---|---|---|
| (2022) | MM | speed/direction | plant | | | D3G7M5 |
| Xiao et al. | ESP8266 | Temperature/ | Indoor lab | Less than | 1 | No |
| (2023) | MCU | humidity | (outdoor solar | 1 day | | |
| | | | panel) | | | |

### SUMMARY OF THE INVENTION

In one embodiment, the present invention concerns a solar energy system for a WSSN collecting data in remote regions that addresses the limitations found in the prior art.

In another embodiment, the present invention concerns a data acquisition system such as Wireless Smart Sensor Networks (WSSNs), that increases the resilience of infrastructure by providing real-time monitoring and data collection of environmental parameters.

In another embodiment, the present invention concerns a network of low-cost flood monitoring sensors, including water level sensors, rain gauges, and communication nodes.

In another embodiment, the present invention concerns a WSSN composed of two differing energy circuits suited for their energy demands. The sensors' energy circuits contain a photovoltaic panel, a lithium-polymer battery, a control device, and a DC-to-DC converter. Whereas the communication nodes contain another photovoltaic panel, a lead-acid battery, and a solar charging controller.

In another embodiment, the present invention concerns a solar energy system for a WSSN collecting data in remote regions composed of several water level and rain sensors, connected via communication nodes.

In another embodiment, the present invention concerns a data acquisition system comprising a communication node and a sensor node; the communication node including a hotspot connected to a first battery which is connected to a first solar panel and the sensor node including a plurality of sensors connected to a second battery which is in communication with a second solar panel.

In another embodiment, the present invention concerns a data acquisition system wherein the hotspot receives power from the first solar panel when the first solar panel is producing sufficient electricity to operate the hotspot and the first battery is charged when the first solar panel is producing sufficient electricity to charge the battery.

In another embodiment, the present invention concerns a data acquisition systems wherein the hotspot receives power from the first battery when the first solar panel is not producing sufficient electricity to operate the hotspot.

In another embodiment, the present invention concerns a data acquisition system wherein the plurality of sensors receive power from the second solar panel when the second solar panel is producing sufficient electricity to operate the plurality of sensors and the second battery is charged when the second solar panel is producing sufficient electricity to charge the second battery.

In another embodiment, the present invention concerns a data acquisition system the plurality of sensors receive power from the second battery when the second solar panel is not producing sufficient electricity to operate the plurality of sensors.

In another embodiment, the present invention concerns a data acquisition system wherein the sensor node further includes a control device adapted to direct power from the second solar panel or second battery to the plurality of sensors.

In another embodiment, the present invention concerns a data acquisition system that further includes a control device adapted to direct power from the first solar panel or first battery to the hotspot.

In another embodiment, the present invention concerns a data acquisition system of sensors which includes a plurality of sonar and rain sensors.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 is an outline of an energy circuit of a sensor for an embodiment of the present invention.

FIG. 2 shows the components of an energy circuit of the sensor nodes (sonar sensor) and their specifications for an embodiment of the present invention.

FIG. 3 shows a circuit diagram of an energy unit for a sonar sensor node for an embodiment of the present invention.

FIG. 4 is an outline of the energy unit for a communication node for an embodiment of the present invention.

FIG. 5 shows the components of communication nodes' of an energy circuit with specifications for an embodiment of the present invention.

FIG. 6 is an outline of the sensor network and its elements with their energy units for an embodiment of the present invention.

FIG. 7A is an illustration of a rain gauge sensor for an embodiment of the present invention.

FIG. 7B is an illustration of a water level sensor sensors for an embodiment of the present invention.

FIG. 8 is an illustration of communication nodes for an embodiment of the present invention.

FIGS. 9A and 9B are graphics of the auxiliary elements (a) sensor stand (b) sign for an embodiment of the present invention.

FIG. 10 shows the deployment locations for an embodiment of the present invention.

FIG. 11 shows the sensor deployment steps for an embodiment of the present invention.

FIG. 12A shows the user interface homepage.

FIG. 12B shows the user interface Field location.

FIG. 12C shows user interface, r4 sensor page.

FIG. 13A shows a voltage graph with slope and duration demonstration used for the voltage evaluation method.

FIG. 13B shows the start and end of charge/discharge process used for the voltage evaluation method.

FIG. 13C the five classes used in the ML model.

FIG. 13D shows the ensembles of discriminant classifiers used for the voltage evaluation method.

FIG. 13E shows the ensembles of discriminant classifiers with optimized hyper parameters used for the voltage evaluation method.

FIG. 14A shows the results of the voltage analysis for the rain sensors during the first week of July showing voltage graphs.

FIG. 14B shows the results of the voltage analysis for the rain sensors during the first week of July showing slop data.

FIG. 14C shows the results of the voltage analysis for the rain sensors during the first week of July showing duration data.

FIG. 14D shows the results of the voltage analysis for the rain sensors during the first week of July showing |slop|×duration data.

FIG. 14E shows the results of the voltage analysis for the rain sensors during the first week of July showing voltage trend of change.

FIG. 15A shows the results of the voltage analysis for the sonar sensors showing voltage graphs.

FIG. 15B shows the results of the voltage analysis for the sonar sensors showing slop data.

FIG. 15C shows the results of the voltage analysis for the sonar sensors (a) voltage graphs showing duration data.

FIG. 15D shows the results of the voltage analysis for the sonar sensors (a) voltage graphs showing |slop|×duration data.

FIG. 15E shows the results of the voltage analysis for the sonar sensors (a) voltage graphs showing voltage trend of change.

FIG. 16 shows the validation in the voltage of the communication nodes' batteries for an embodiment of the present invention.

FIG. 17 shows the experimental evaluation's summary of the rain, sonar, and node (temperature and humidity) sensors for an embodiment of the present invention.

### DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

### Energy Harvesting System

In one embodiment, the present invention concerns an energy harvesting system designed for low-cost remote sensors equipped with real-time monitoring systems. The system's two main components are sensor nodes and communication nodes.

### Outline of the Circuit

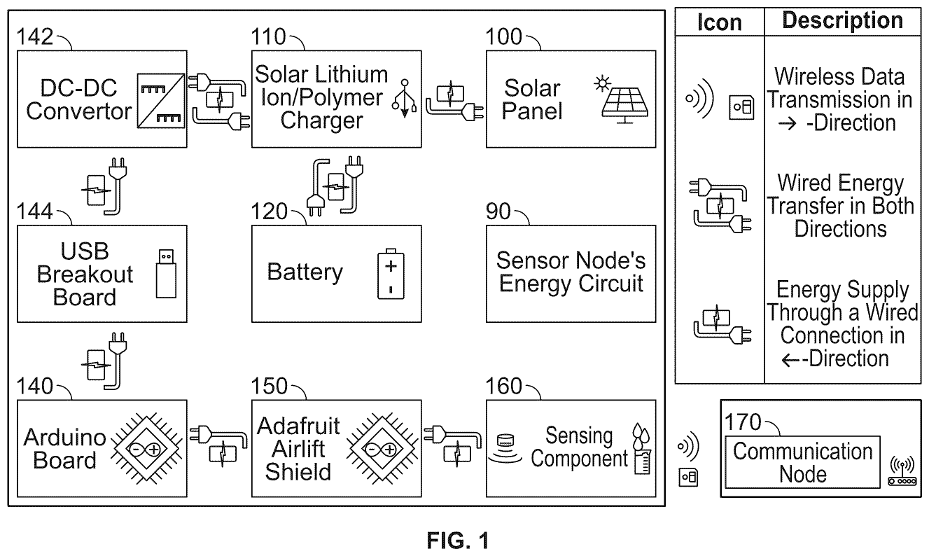

FIGS. 1-3 show the connection between the basic components of the sensor node's energy circuit 90 which includes a photovoltaic panel 100 that collects solar energy during daytime and through the use of charger 110 charges battery 120 which may be a lithium polymer battery while also powering a microcontroller 140 which may be an Arduino Uno board through DC-DC converter 142 and breakout board 144. The DC-DC converter boosts the DC voltage received from the panel to the degree required to operate of the Arduino Uno board. The battery in this system reserves solar energy during the day and automatically powers the circuit during the nights or temporary shades for transmission of the data collected. Additionally, an on-board ESP32 chip that is attached on top of the Airlift Shield 150 provides the necessary wireless capabilities. Also included are one or more sensors 160 and communication node 170.

### Circuit Components and Diagram

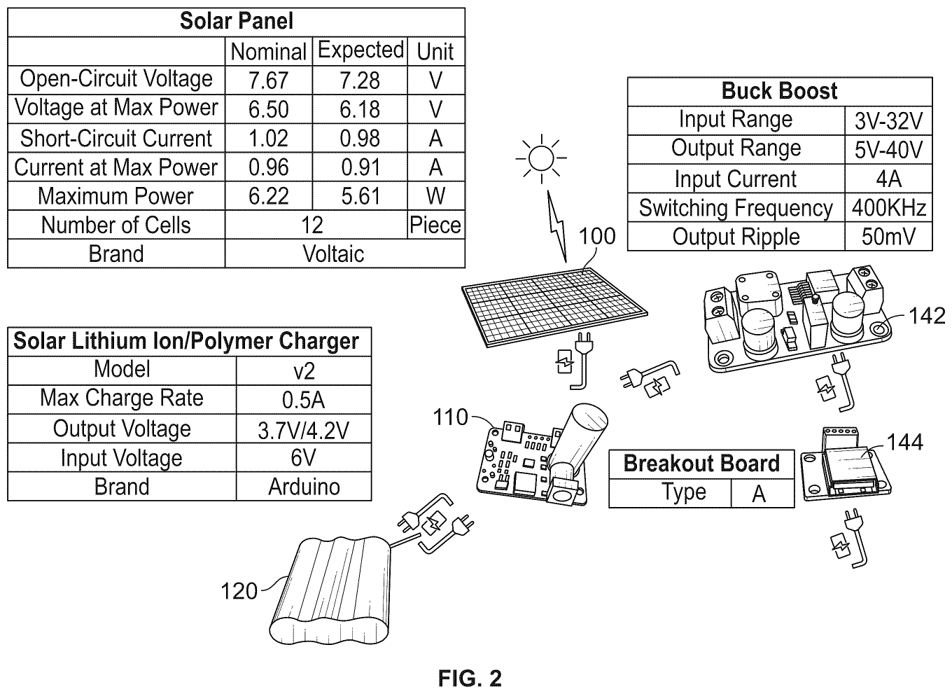

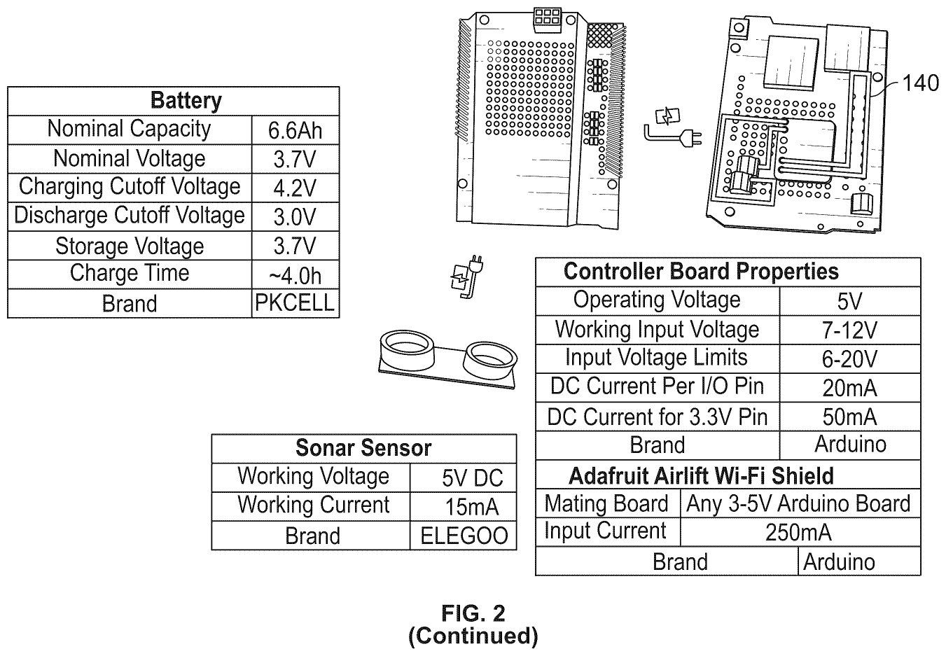

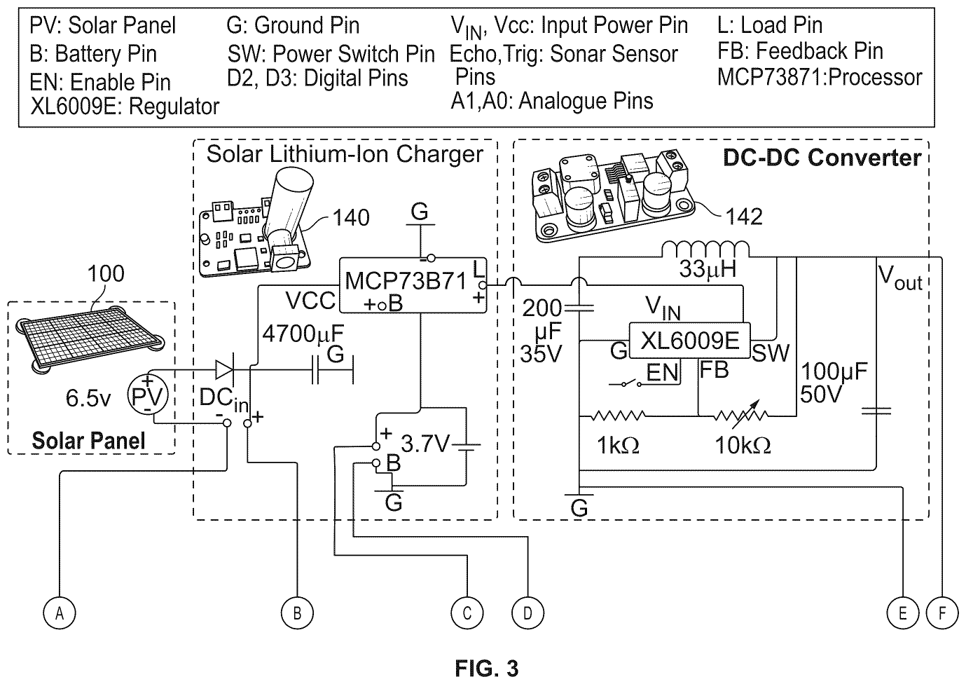

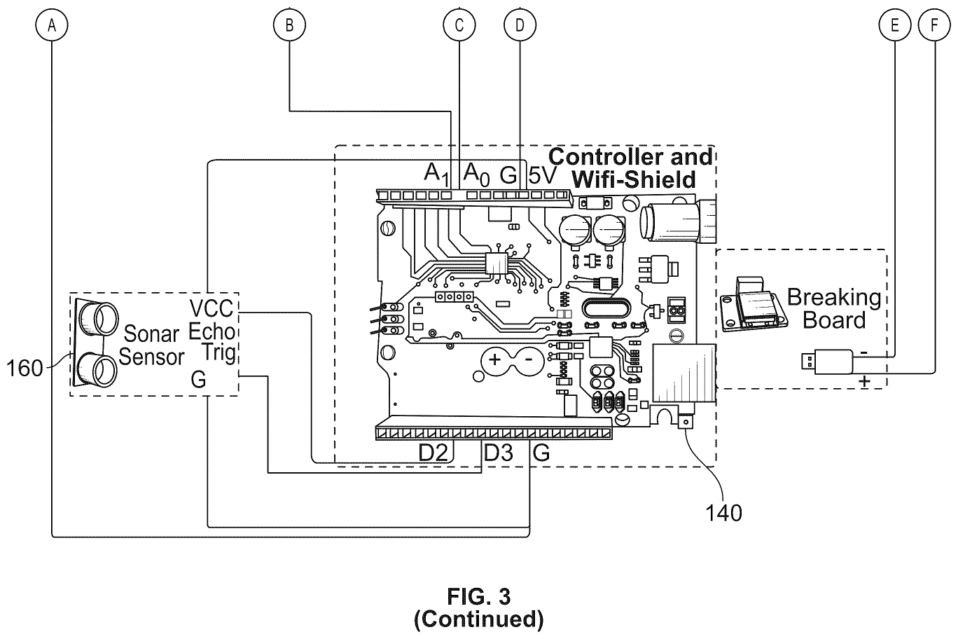

FIG. 2 schematically shows the components of the sonar sensor node's energy circuit with their specifications. FIG. 3 shows the circuit diagram of this node. A 6.22 W 6.5V solar panel is connected to a solar lithium-ion charger including a 4.7 F capacitor and a mcp73871 microchip for voltage regulation.

This charger establishes a bidirectional and unidirectional energy transfer with a 3.7V lithium-polymer battery and a DC-DC converter, respectively. On a sunny day, the solar panel charges the battery and supplies input to the converter at a voltage range of 6V-6.5V. The DC-DC converter then bucks the output voltage to 5.4V-5.6V. At night, the battery supplies the input of the converter at a voltage range of 3.2V-4.2V. The converter boosts the voltage to 5.2V-5.5V. This output range of converter's voltage safely operates the Arduino which functions on 5V logic. Two main components attached to the Arduino boards are a sensor and the Adafruit Airlift Shield with an on-board ESP32 chip providing wireless transmission capabilities. The on-board ESP32 is integrated into the Adafruit Airlift Shield and is not shown as a separate component in the circuit. The sonar sensor is connected to the Arduino through a ground pin, a 5V power pin, and 2 digital Input/Output (I/O) pins. These digital pins (D2 and D3 in FIG. 3) can be replaced with other digital pins through the code. The circuit diagram of rain sensors is similar to sonar sensors' diagram and therefore is not shown in this section. The only difference between the circuit diagram of rain sensors with FIG. 3 is the connection between Arduino board and the sensor. The rain sensors have the same power input and ground connection pins as sonar sensors, but only one digital pin (D3) is used for data transmission as opposed to the two digital pins in sonar sensors (D2 and D3). In addition, when the network is not available, the embodiments of the present invention are adapted to save data without the use of a network connection such as through the use of SD cards.

### Calculations and Prototype Evaluation

The panel size is assessed based on the ratio of the yearly peak sun hour and energy consumption. The yearly peak sun hour for a south facing flat-plate collector at a fixed tilt is 5.6 kW h/m2/day in New Mexico. The power consumption is empirically measured using a multimeter from which the annual energy consumption of a node is estimated at 6861.1 W·hr for sonar sensor. Selecting a typical derate factor equal to 0.77 approximates various losses and inefficiencies in the PV system components (Marion et al., 2005). A conservative shade factor of 0.7 is applied to the default derate factor decreasing it to 0.54. Annual energy required by the solar panel is:

$$Anual required energy = \frac{anual energy consumed by loads}{solar panel derate factors} = \frac{6861.1 W . hr}{0.54} = 12705.7 W . hr$$

$$Solar panel ' s power = \frac{anual required energy}{annual peak sun hour} = \frac{12705.7 W . hr}{\frac{3.6 \times 1000 \frac{W . hr}{{m}^{2} days} \times 365 days}{1000 \frac{W}{{m}^{2}}}} = 6.2 W$$

The battery's capacity is analyzed based on the daily load of the sensor for one day of autonomy during summer. Additionally, the Depth of Discharge (DoD) for each lithium-ion polymer battery is considered 85%. The daily load of a sonar sensor is experimental evaluated at

$$Daily load = \frac{annual load}{days in a year} = \frac{6861.1}{365} = 18.79 W . hr$$

And the subsystem losses include: Wiring losses: 97%; Conversion efficiency: 92%; Round-trip efficiency 95%. Value of 77% has been chosen to account for the battery capacity drop at lower temperatures (when the ambient temperature drops to −15° C. from the battery test temperature).

$$Battery capacity = \frac{daily electric load \times days of autonomy \times temperature conversion factor}{voltage \times load subsystem efficiency \times depth of discharge} = \frac{18.79 \times 1 \times 1.23}{5 \times 0.95 \times 0.97 \times 0.92 \times 0.85} = 6.3 A . hr$$

After selecting the battery and the solar panels based on the results of calculations, other components of sensor node's energy circuit were selected based on the consistency of electrical characteristics of the connected components also considering that the sonar sensors are fed with 5V input.

The battery's capacity is assessed based on the sensor's daily load for one day of autonomy during summer. A 60% Depth of Discharge (DoD) is considered for each lead-acid battery. The daily load of a sonar sensor is experimentally determined as 66 W·hr. Subsystem losses include wiring losses (97%), conversion efficiency (92%), and round-trip efficiency (95%). A value of 77% is chosen for the battery capacity drop at lower temperature.

$$Battery capacity = \frac{daily electric load \times days of autonomy \times temperature conversion factor}{voltage \times load subsystem efficiency \times depth of discharge} = \frac{66 \times 1 \times 1.23}{5 \times 0.95 \times 0.97 \times 0.92 \times 0.6} = 31.9 A . hr$$

### Energy Circuit of Communication Nodes

### Outline and Components of the Circuit

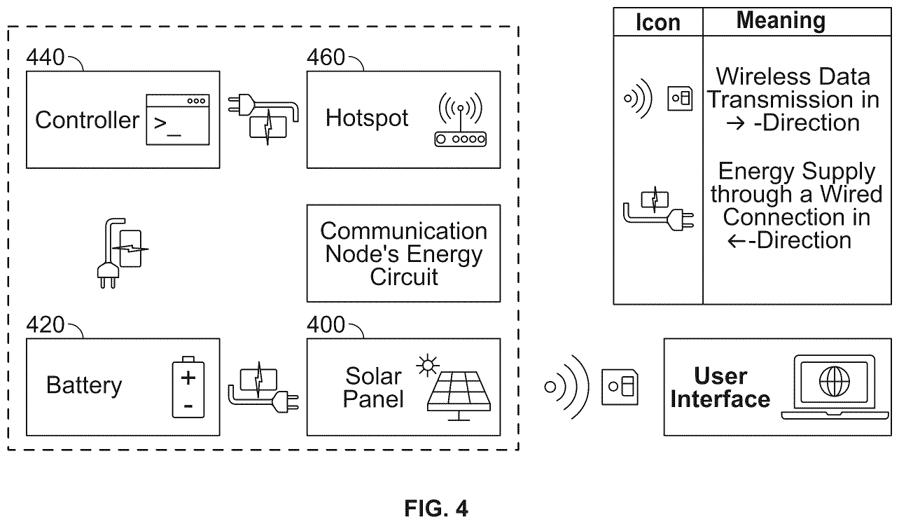

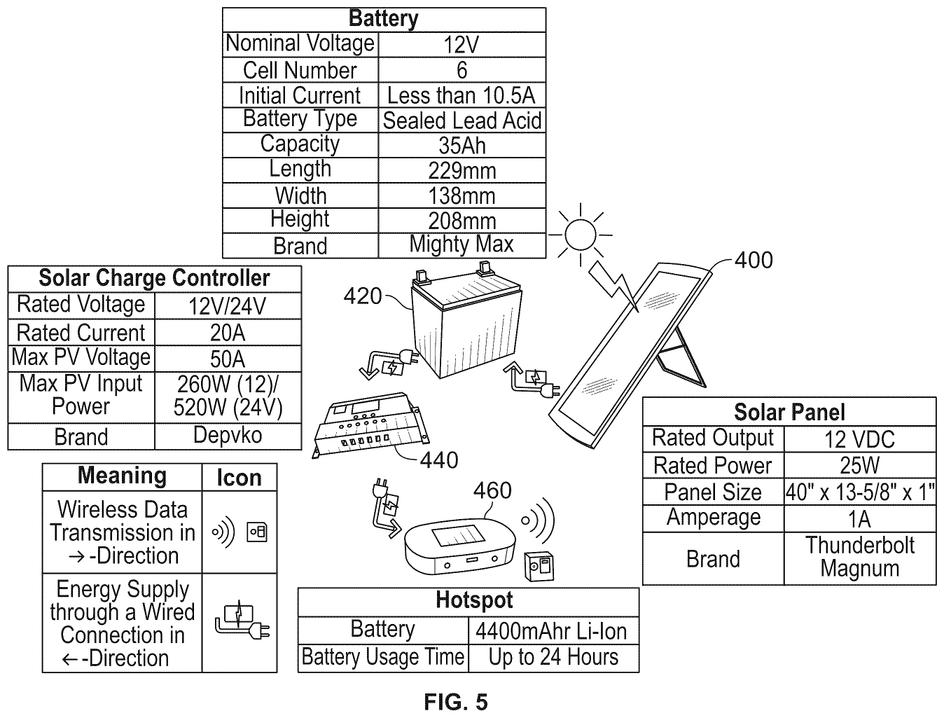

FIG. 4 shows the basic components of the communication node's energy circuit and their connections which include solar panel 400, battery 420, controller 440 and hotspot 460. FIG. 5 provides the specifications and demonstrates the schematic illustration of the components of the communication node's energy circuit.

During sun hours, solar energy is captured by a 25 W solar panel to fill a 12V lead-acid battery that powers a portable hotspot with a 4400-mAh lithium-ion battery. The hotspot connects to a 12V/24V-20 A charge controller through which it receives the battery's electricity. The benefits of the charge controller include: (1) optimizing the transferred power by adapting the circuit's operation at maximum power point regardless of variations in irradiation; (2) shortening the charging time; (3) increasing the battery's life by preventing excessive charge and discharge. Overall, the circuit provides efficient and sustainable energy harvesting power for the unit that provides continuous online connectivity to its respective sensors.

### Calculations and Prototype Assessment

The panel size is determined by the ratio of the yearly peak sun hour and energy consumption. In New Mexico, the peak sun hour is 6.2 kW h/m2/day for a 45° flat-plate collector. The measured energy consumption of a hotspot is 8030 W·hr during a year, and each communication node supports up to three hotspots. A derate factor of 0.54 is applied to account for system losses and shading as described in section 2.1.3. The annual energy required by the solar panel is calculated accordingly:

$$\begin{matrix}Anual required energy = \frac{anual energy consumed by loads}{solar panel derate factors} = \frac{24090 W . hr}{0.54} \\ = 44611.1 W . hr\end{matrix}$$

$$Solar panel ' s power = \frac{anual required energy}{annual peak sun hour} = \frac{44611.1 W . hr}{\frac{6.2 \times 1000 \frac{W . hr}{{m}^{2} days} \times 365 days}{1000 \frac{W}{{m}^{2}}}} = 19.7 W$$

### 3. Implemented WSSN

The present invention implements a low-cost sensor network run by the proposed power architecture to evaluate the performance of the energy system. The network consists of various components, including sensors, communication nodes, and auxiliary systems.

### WSSN

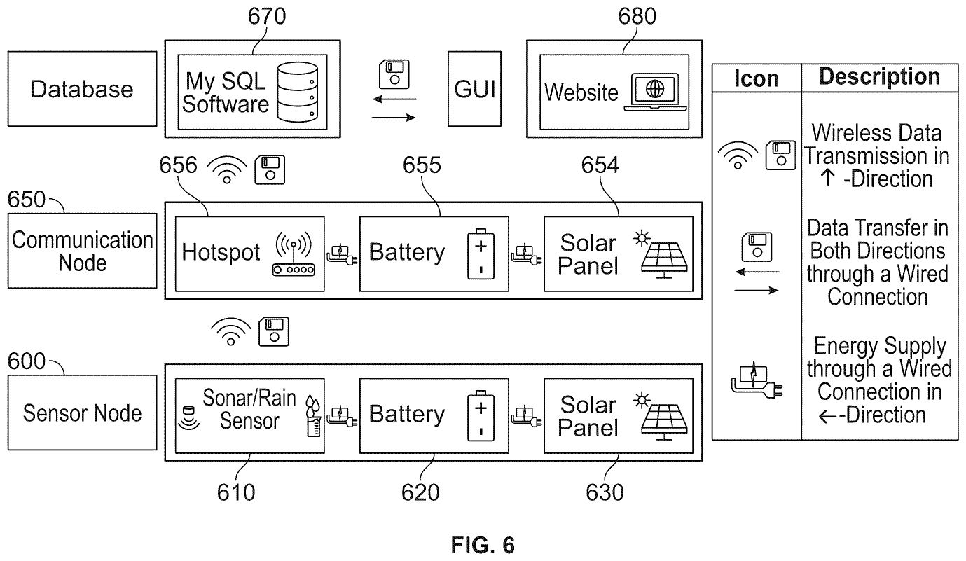

FIG. 6 shows the basic blocks and connections of a sensor node 600 of an embodiment of the present invention. This node includes one or more sensors 610 which may be a sonar or rain sensor which are powered by batteries 620 which is charged by solar panel 630. Communication node 650 which includes solar panel 655, battery 654 and hotspot 656. Also included are database 670 and user interface 680.

The process proceeds with sensors collecting data of precipitation and water level then, transmitting the data to the communication nodes. These communication nodes are hand-held hotspots, which enable a connection from the sensors to a database that permanently stores the data collected. The database then relays the data to the Graphic User Interface (GUI) of the network; a website where the data are plotted and presented in final format.

When connectivity is unavailable, the collected data is stored locally aboard the SD Card component aboard the Adafruit Airlift Shield. Once connectivity is established the previously collected data is transmitted to the database.

### Sensor Description

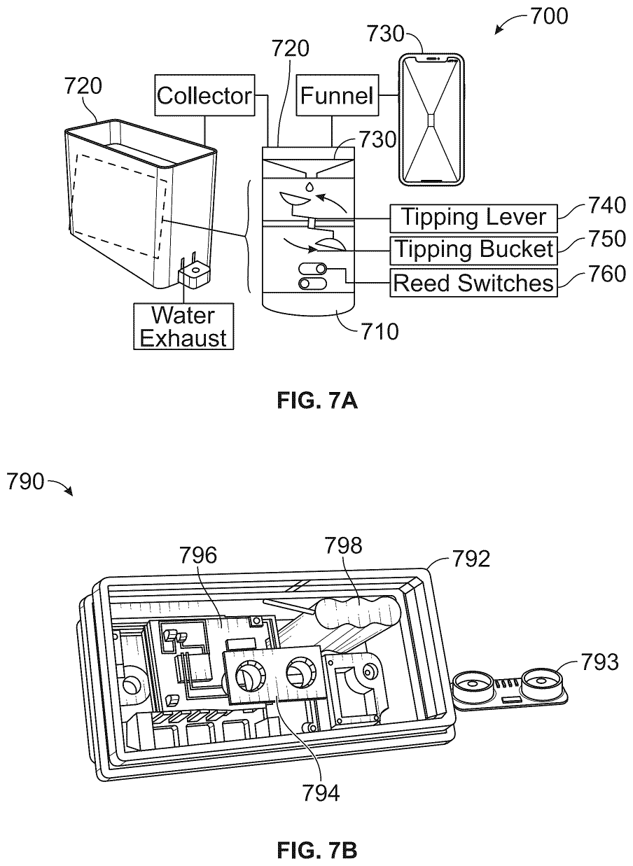

The network of low-cost sensors may be comprised of twenty rain gauges and twenty-six water level sensors positioned in six different places. FIG. 7A provides a schematic illustration of rain gauge 700 for an embodiment of the present invention. The rain gauge may have a tilting mechanism 710 that includes a rainwater collector 720, a funnel 730, a tipping lever 740, a tipping bucket 750, and reed switches 760. The rainfall is collected inside the collector and channeled through the funnel toward the tipping buckets. Each bucket's tip is approximately equivalent to 0.28 mm of rainfall, and once the tip occurs it creates momentary contact closure with its respective reed switch that is recorded via an interrupt pin signal. FIG. 7B is a schematic illustration of the water level sensors 790 and box 792 encompassing the electrical assembly of both sensors. The ultrasonic measuring component 793 is mounted via a 3D printed sonar holder 794 to an impact resistant and durable ABS plastic junction box then connected to an Arduino board 796 powered by a 3.7V lithium polymer battery circuit 798. Table 2 shows the specifications of the sonar component used in the deployment. The rain and sonar sensors may be used to improve flood prediction in waterways. Flooding is one the five extreme events that poses a significant threat to social stability and economic growth in regions prone to floods. The data required for flood prediction is usually collected at inaccessible off-grid areas. The ultrasonic measuring component 793 is mounted via a 3D printed sonar holder to an ABS plastic junction box then connected to an Arduino board powered by a 3.7V lithium polymer battery circuit. Table 2 shows the specifications of the sonar component used in the deployment. The prospect of using rain and sonar sensors is to improve flood prediction in waterways. Flooding is one the five extreme events that poses a significant threat to social stability and economic growth in regions prone to floods.

TABLE 2
Sonar component specifications.

| Brand | ELEGOO |
|---|---|
| Model | HC-SR04 |
| Max Range | 500 cm |
| Min Range | 2 cm |
| Measuring Angle | 15° |

The data required for flood prediction is usually collected at inaccessible off-grid areas. The rain sensors are used to measure the intensity and duration of rainfall in real-time, which is a critical factor in determining the likelihood and severity of flooding. The sonar sensors, on the other hand, are used to measure water levels and the flow rate of water in the waterways. Combining the data from the rain and sonar sensors will potentiate developing flood prediction models that can provide early warnings and help mitigate the damage caused by flooding.

### Deployed Communication Nodes

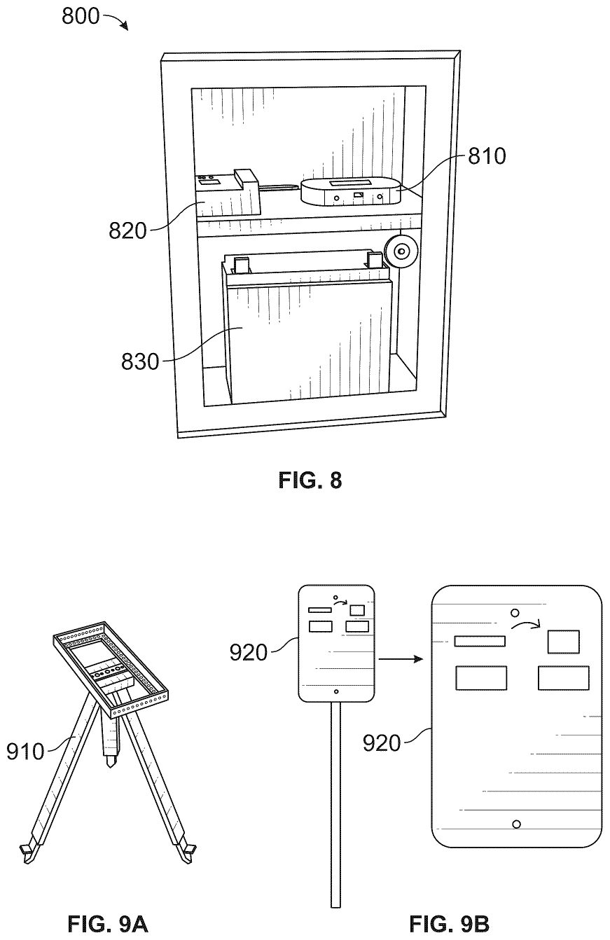

In conjunction with every three sensors deployed, a communication node 800 is attached providing internet connection; amounting to a total of 8 for the network studied. These communication nodes are schematically illustrated in FIG. 8, showing the main component being a mobile hotspot 810, controller 820, battery 830 that receives and transmits data from sensor to the server.

The other components are composed of an energy circuit, which contains a solar charging controller, as described above, that directs collected energy to provide a constant charge to the hotspot and provides external protection of the internal electrical devices during long term outdoor operation. Table 3 provides the specifications of the hotspot such as its dimensions, weight, operating temperature, security features, maximum possible connections, supported operating systems, and theoretical download speed.

TABLE 3
Hotspot communication node specification

| Brand | MiFi | |
|---|---|---|
| Wireless Technology | Global Cat 9 LTE HSPA+/ | |
| | UMTS/EDGE/GPRS, 1x/EV-DO | |
| Max Theoretical Download | 450 | Mbps |
| Speed | | |
| Wi-Fi Version | 802.11 | b/g/n/ac |
| Max Connection | Up to 15 Devices | |
| Security Features | Wi-Fi Security (WPA/WPA2) | |
| | Wi-Fi Protected Setups (WPS) | |
| | Wi-Fi Privacy Separation | |
| System Support | Windows 7, 8, 10 | |
| | Mac OS 10.7 or Higher | |
| | Linux Ubuntu 12.4 or Higher | |
| Wi-fi Bands | 2.4 GHz and 5 GHz Simultaneous | |
| Dimensions | 109 × 67 × 18 | mm |
| Weight | 152 | gr |

| | |
|---|---|
| Operating Temperature | −10° C.-55° C. |

### Auxiliaries

Several auxiliary elements such as sensor stands, fasteners, and signs are required for sensor deployment. The schematic illustration of the sensor stands 910 and signs 920 used in this study are presented in FIG. 9.

The stand is one of the installation methods used to fix the sensors in their locations of operation. The final designs of the stands, such as the shape and dimension of the seat depend on the combination of the sensors installed on them. The sign gives a friendly message about the significance of the sensor network for the local community in English and Tewa (Ohkay Owingeh Pueblo's native languages).

### Total Cost of System

The cost of the major components of the sensors and communication nodes for small-scale production are listed in Table 4. The purchase link for each item is also provided in a separate column in the table. The total cost of the main components of a sensor node and a communication node are $152.62 and $303.93, respectively. Each communication node can handle connectivity and data transfer for up to fifteen sensors which can decrease the costs of a network depending on the configuration desired.

TABLE 4
Total cost of the main components
of sensor and communication nodes.

| Items | Prices | Links |
|---|---|---|
| Sensor Solar Panel | $69.00 | https://www.adafruit.com/product/1525 |
| Buck Boost | $1.84 | https://www.amazon.com/HiLetgo- |
| | | Adjustable-DC3-0-30V-DC5-35V- |
| | | Converter/dp/B00LP2LZ4M |
| Solar Lithium Ion/ | $17.50 | https://www.adafruit.com/product/390 |
| Polymer Charger | | |
| Arduino UNO R3 | $26.79 | https://www.amazon.com/Arduino- |
| | | A000066-ARDUINO-UNO- |
| | | R3/dp/B008GRTSV6 |
| Sonar Sensor | $12.99 | https://www.amazon.com/ELEGOO-HC- |
| | | SR04-Ultrasonic-Distance- |
| | | MEGA2560/dp/B01COSN706 |
| Sensor Battery | $24.50 | https://www.adafruit.com/product/353 |
| Communication | $69.99 | https://www.harborfreight.com/25-Watt- |
| Node's Solar Panel | | solar-panel-63940.html?utm_source |
| Communication | $69.99 | https://www.amazon.com/ML35-12- |
| Node's Battery | | Battery-Mighty-Brand- |
| | | Product/dp/B00K8V2VD0 |
| Solar Charger | $14.92 | https://www.amazon.com/Controller- |
| Controller | | Intelligent-Regulator-Paremeter- |
| | | Adjustable/dp/B08L8TBCK6 |
| Hotspot | $149.03 | https://www.amazon.com/Verizon- |
| | | Jetpack-Hotspot-WiFi- |
| | | Device/dp/B09LYMZ49Q/ref |
| Wi-Fi shield | $14.95 | https://www.adafruit.com/product/4285 |
| Total Cost | $471.50 | |

Low-cost WSSN is a solution to large-scale automation and data-acquisition systems such as ocean of things and smart cities. The cost-efficient nature of these components allows for a more accessible and scalable deployment, enabling a larger number of sensors to be integrated into the network within the available budget. This increased sensor density enhances data collection capabilities and improves the spatial coverage of the network.

### Deployment

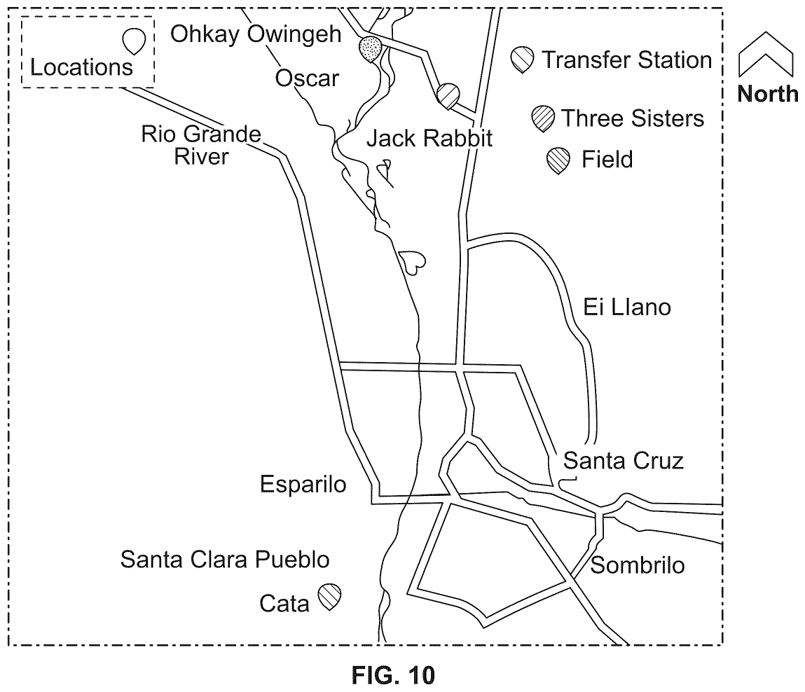

To validate the energy system in a real-world field application, the researchers deployed the sensors in six uncultivated lands within the northern pueblo of Ohkay Owingeh, New Mexico, USA. FIG. 10 provides the map and designation of the deployment locations. The performance of the networks' energy systems in these locations was monitored the from May 1, 2022, to Nov. 1, 2022.

### Deployment Process

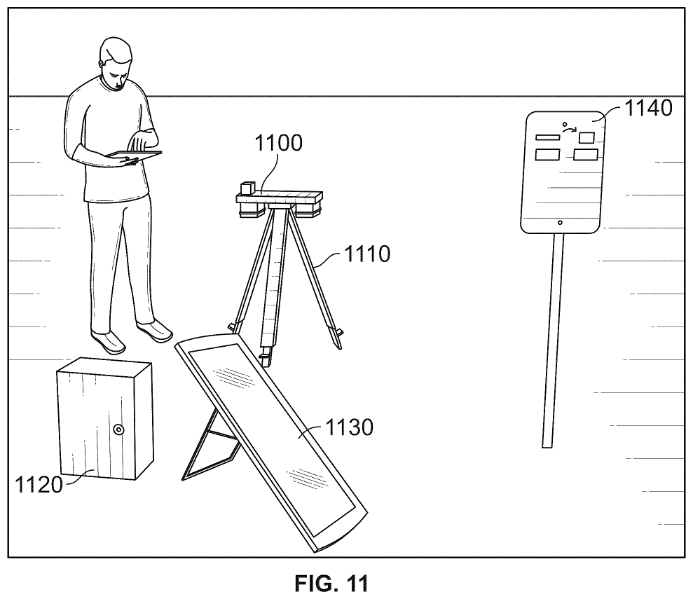

The deployment process included: (1) transferring the qualified sensors, hotspots, energy devices, and the auxiliary parts to the planned locations, (2) installing the devices in the field, (3) establishing the required connections between sensor nodes, communication nodes, and the user interface, and (4) verifying the operation of the sensors on the online interface. FIG. 11 shows the schematic illustration of the deployment process of a sonar sensor 1100 mounted on stand 1110 powered by battery 1120 and solar panel 1130 along with sign 1140.

First, a sign and a stand were fixed to the ground. Next, the assembled sensor node and its energy circuit were attached to the stand. A hotspot, its battery, and a charge controller were positioned inside a box and the 25 W solar panel was placed adjacent to the box. Lastly, the researchers verified wireless connectivity between the sensor, the hotspot, and the user interface using a laptop. To address the imperfections of solar-based energy harvesting because of daylighting variations, the researchers deployed solar panels toward the south with tilt angles between 0 and 45° that is approximately the latitude of the locations plus 15°. These range and direction are recommended by the US National Renewable Energy Laboratory (NREL) for capturing the highest average yearly solar radiation when utilizing flat panels. Additionally, the panels were positioned in locations under no or negligible shading conditions to achieve maximum possible sunlight. To tackle the imperfections of solar-based energy harvesting caused by weather variations especially preventing the battery charge drop because of low temperature effect, the research group designed a winter isolation system for the deployed batteries including the 3.7V lithium-polymer batteries of the sensor nodes, the 12V lead acid batteries of the communication nodes, and the hotspots. Additionally, the boxes' design including their size and natural ventilation prevented overheating of the electric devices inside them during the field deployment.

### Results and Assessments

The sensor readings are saved on a server database and then are plotted on the GUI which together constitute the user interface of the sensor system. Because the data presented for assessing the sensors are achieved from this frontend, this section first describes the user interface. Next, it explains the approach used for automating voltage evaluation and then explores the graphs of the batteries and solar panel's voltages for some sensor nodes. Afterwards, the voltage variations in communication nodes' batteries are discussed and finally the uptime and downtime of 54 sensors including 26 sonar sensors, 20 rain sensors and 8 temperature/humidity sensors are presented and analyzed for one month. These findings provide insights into the effectiveness of the designed energy circuits and the system's overall reliability.

### User Interface

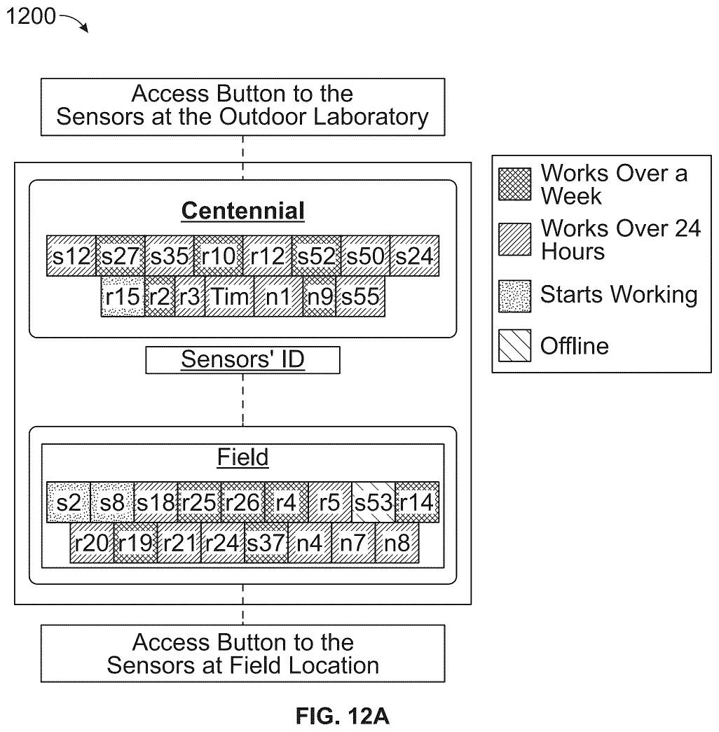

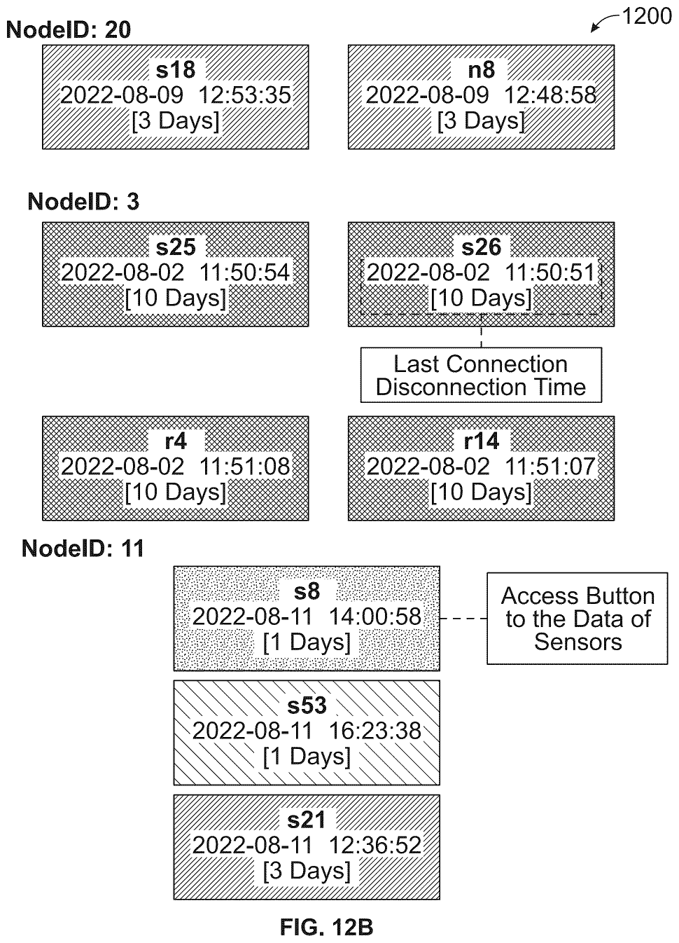

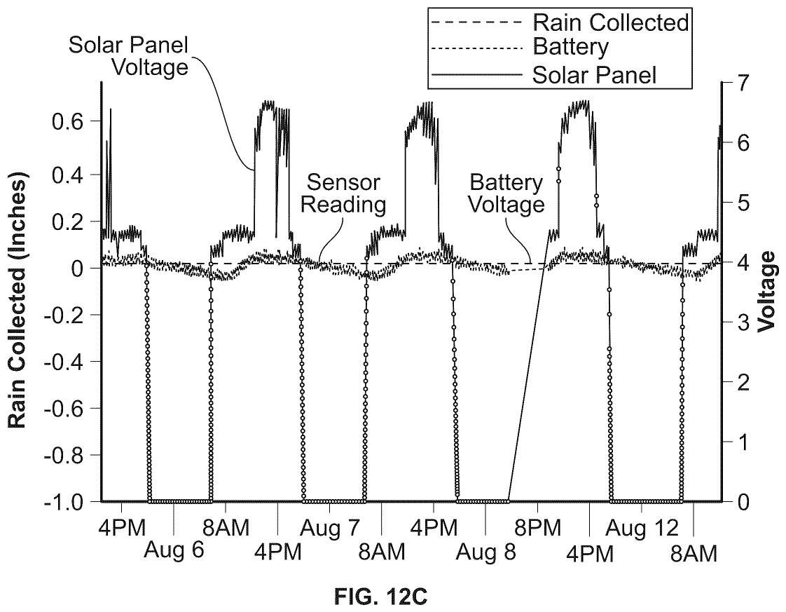

The user interface includes two main elements: (1) a Structured Query Language (SQL) database with limited access and (2) an open-access internet website implemented in JavaScript. The SQL database stores any data collected by the sensor network and provides a means for high-level non-real-time data analysis. Whereas the website acquires the recent data from the database, retains it for a limited time, conducts noncomplex processing and presents the data in a graph format. The transmission interval from the sensors is currently every 30 s but data-transfer from sensor to the database and from the database to the website is in real-time. Furthermore, the data processing and demonstration within the java scripts of the website is performed in real-time. Therefore, the update time of the website in the current format is approximately 30 s. FIGS. 12A-12C shows the website 1200 and describes its basic elements.

In its homepage, the website 1200 provides the access buttons to each deployment location as demonstrated in FIG. 12A. The designation of the sensors at different locations are demonstrated with different colors on the homepage but access to individual sensors is through the location buttons. Each color represents a condition: blue sensors have unimpededly functioned for more than a week; green represents the sensors that have worked for 48 hr to one week without disconnection, orange sensors have operated for less than 2 hrs; and red sensors are disconnected. A location page provides the access buttons to every sensor in that location and gives some information on the condition of each sensor and communication node as depicted in FIG. 12B. The user can access the collected data using sensors' access buttons through which plots of the latest update of the sensors' measurements are presented. FIG. 12C shows an example of collected data of rain by sensor r4 from the website. Additionally, the voltages of solar panels and batteries are updated every 30 s on the website offering a means for sensors' energy monitoring in—real-time.

### Automated Voltage Analysis

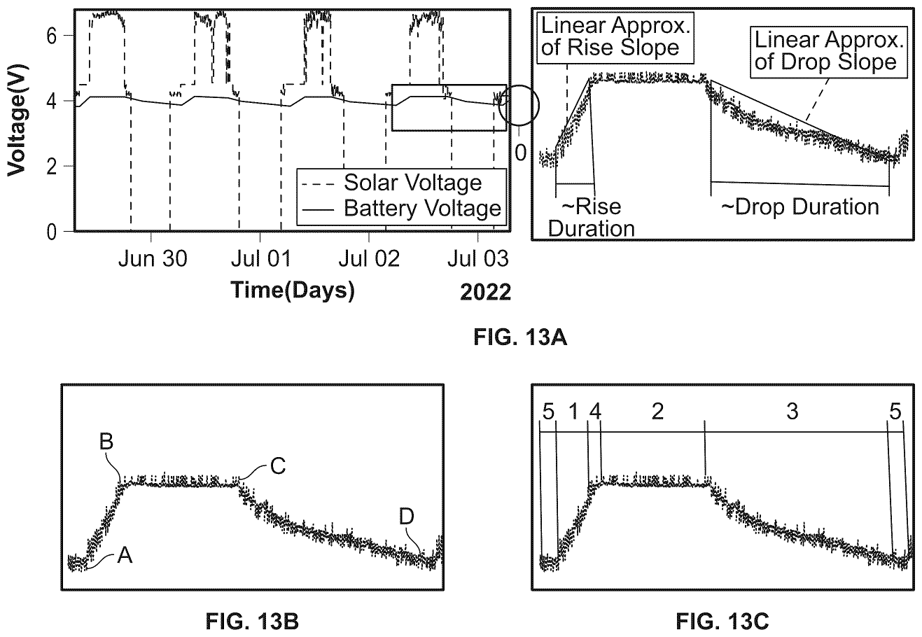

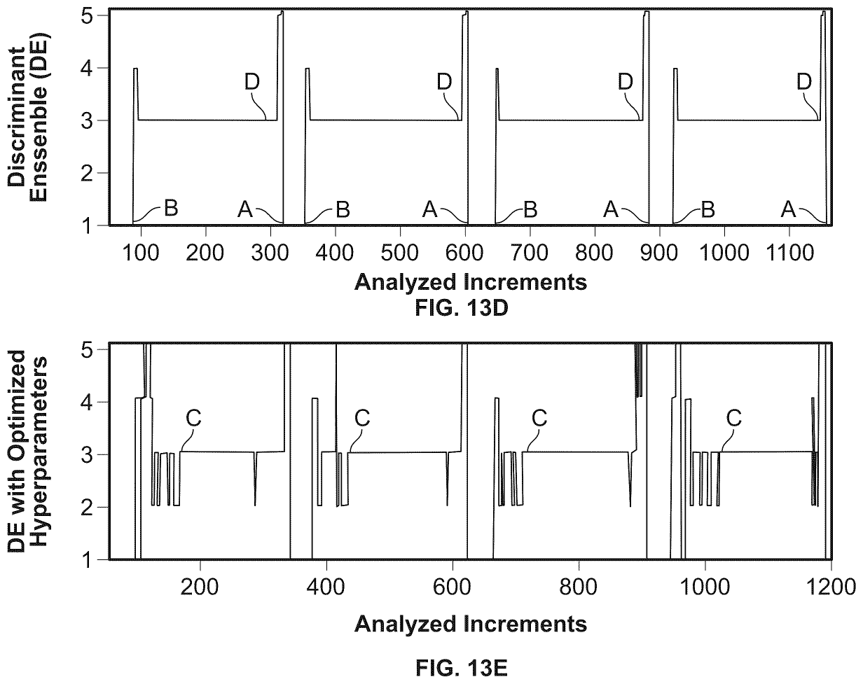

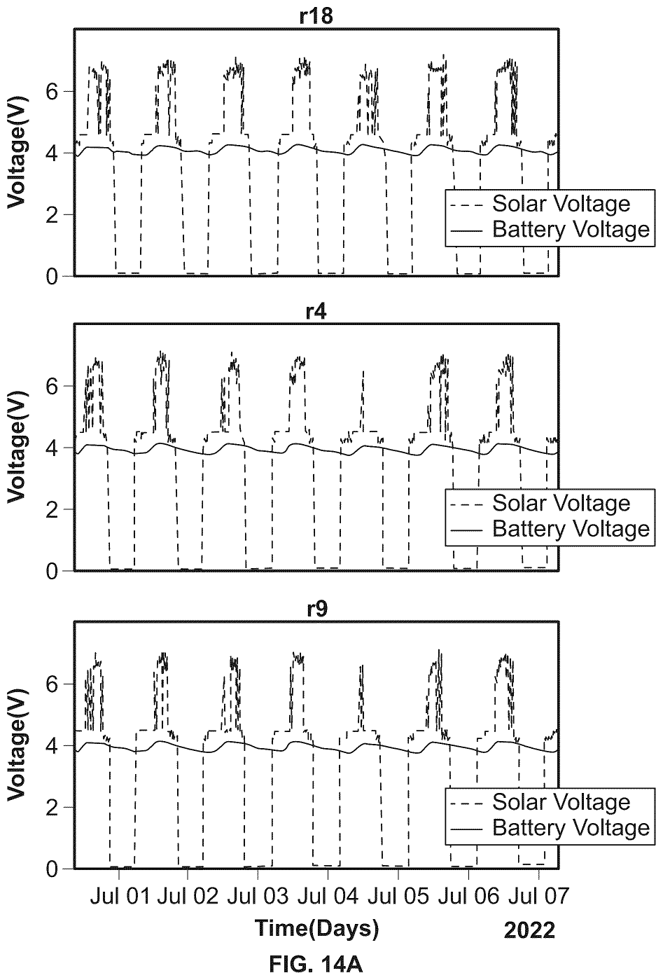

The discharge cutoff voltage of the sensor nodes' batteries may be around 3.0V. Reducing the voltages beyond this level is harmful for the batteries thus it is required they remain above this limit during normal operation. However, the voltage will not fall beyond the cutoff level if the increase in voltage during charging is capable of compensating for the decrease during discharge. Therefore, the assessment criterion specified for the sustainability of the sensor nodes in this study is the direction of change in the voltages of the sensor. Specifically, the slope and duration of voltage drop/rise are analyzed for a period of in-field operation through which the overall trend is calculated. FIGS. 13A-E describe the employed method to calculate the slope and duration of drop and rise in the batteries' voltages using an exemplary sensor deployed at the Three Sister location in Ohkay Owingeh.

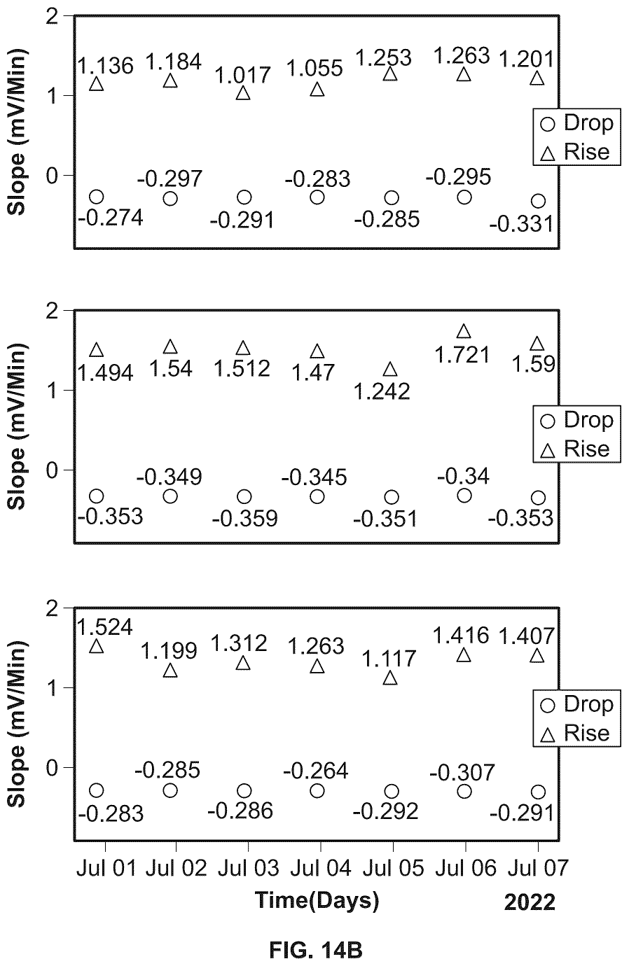

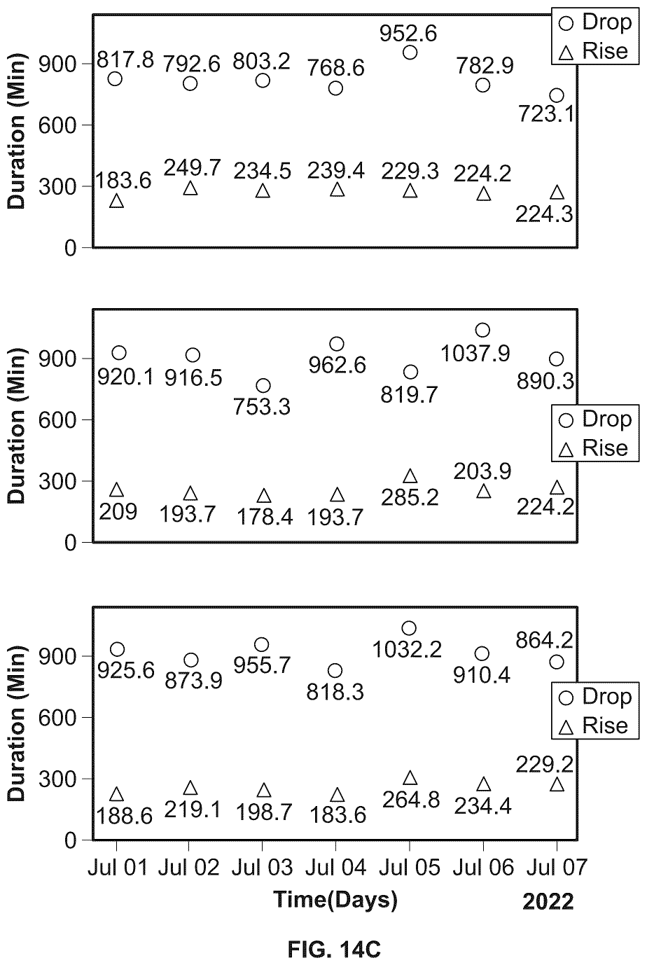

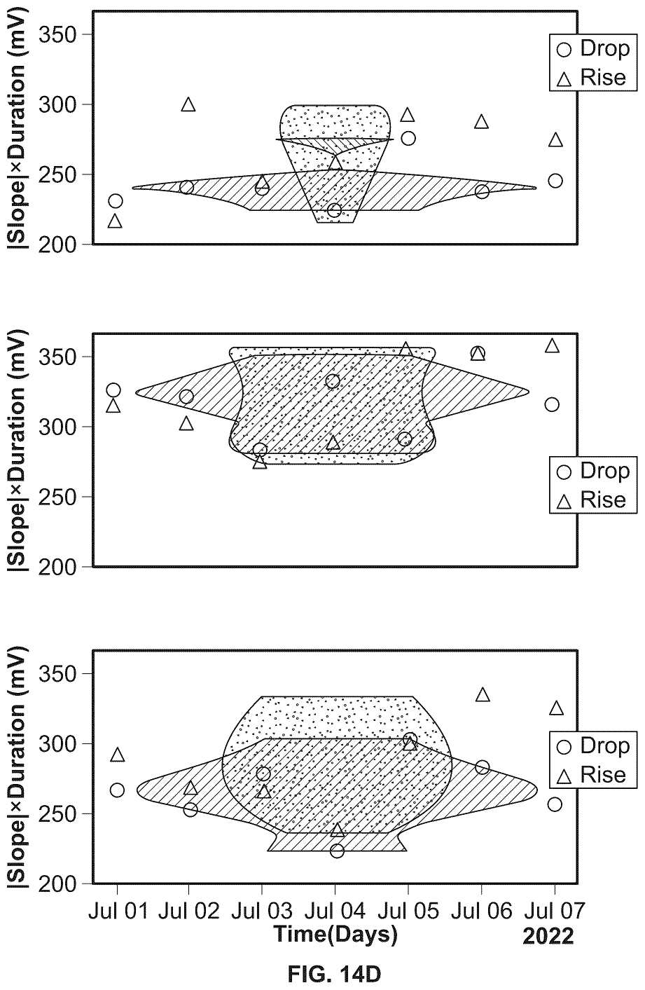

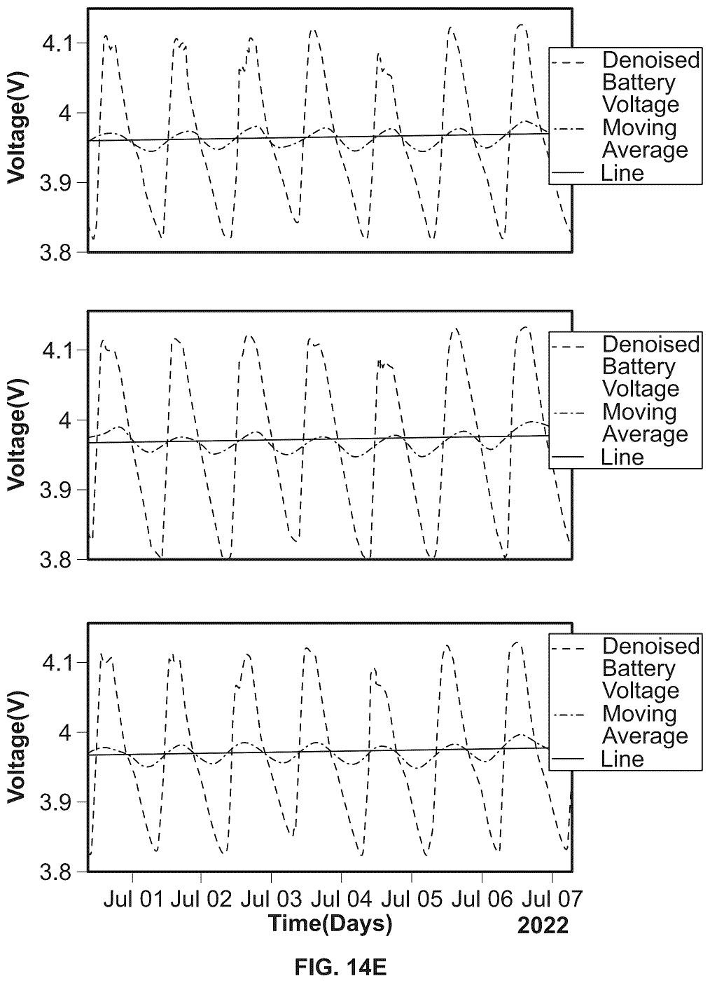

The battery and solar panel voltage data in FIG. 13A is acquired from the user interface. FIG. 13a also shows the linear approximation of the mentioned slopes and durations for that sensor. This approximation requires estimation of the start as well as the end of the charge and discharge processes. FIG. 13b signifies those starts and ends with four letters: A and B are the start and end of the charge process, while C and D are the start and the end of the discharge process. This study uses a supervised Machine Learning (ML) approach to automatically detect these points during charge and discharge and subsequently computes the mentioned slopes and durations. Five classes for voltage data are defined as described in FIG. 13c and the data of several sensors are accordingly tagged for training the model. The features used in the ML model include the slopes of the lines starting from the point of interest and ending at different increments. Different classification techniques are employed and tested with diverse test-sets to identify a model with the desired accuracy, in turn, an ensemble learner with discriminant classifier is used to extract the start of charge (A) and the end of charge and discharge processes (B and D, respectively) as shown in FIG. 13d. This classifier, however, fails to detect the start of discharge (C), thus, a second model with the same classifier but with optimized hyperparameters are employed as shown in FIG. 13e. Finally, an algorithm based on the pattern of the class variation in the second model detects the start of the discharge process and subsequently calculates the slopes and durations. MATLAB was utilized for training and parameter identification of the ML model, the classification implementation, and the computation of the voltage slopes. The results show that if the batteries' initial voltage is above 4.1V, the designed energy circuit described in FIG. 2 can provide power for them to operate above their cutoff voltage for one week in remote locations. For example, one-week evaluation of the rain sensors in FIGS. 14A-E show that the minimum voltage of r4, r9, and r18 are 3.78V, 3.82V, and 3.84V.

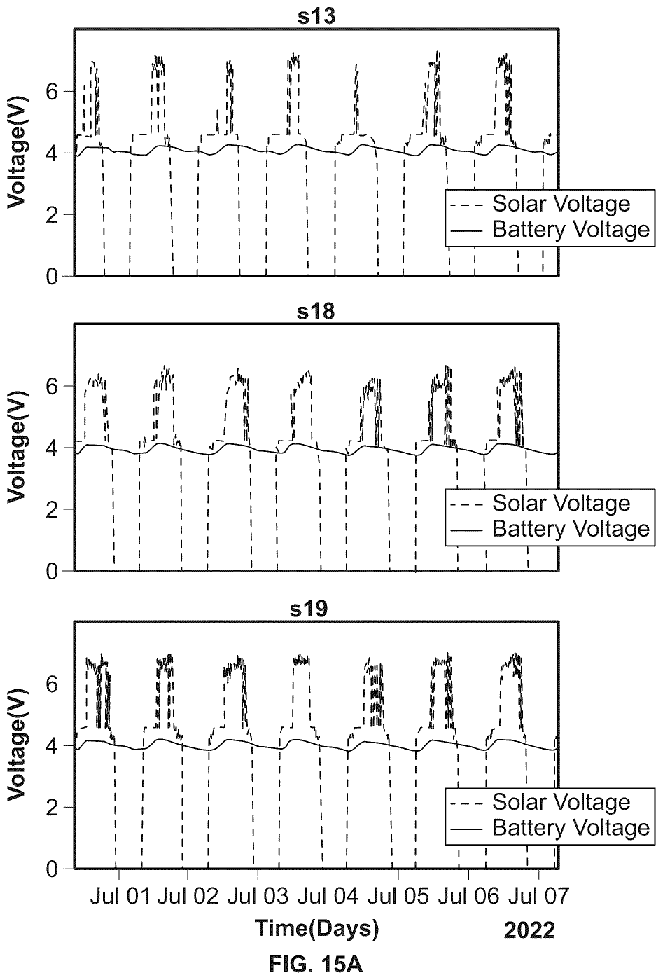

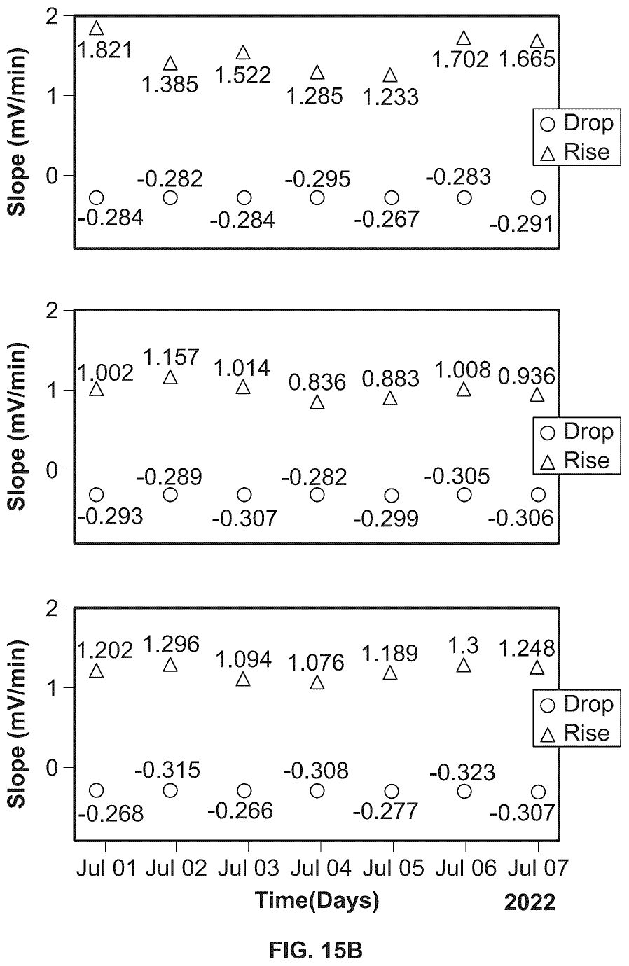

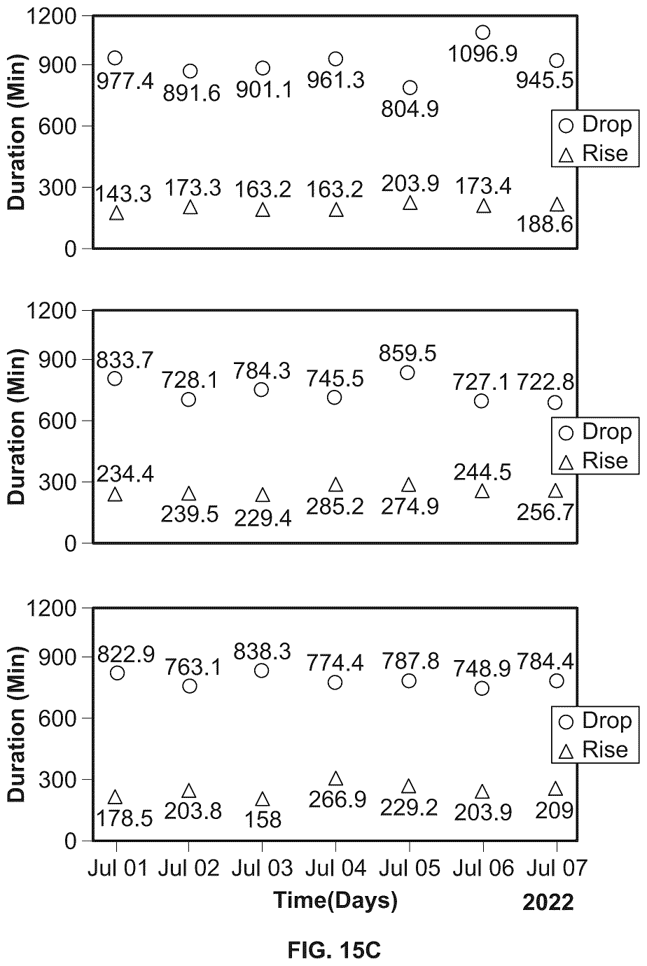

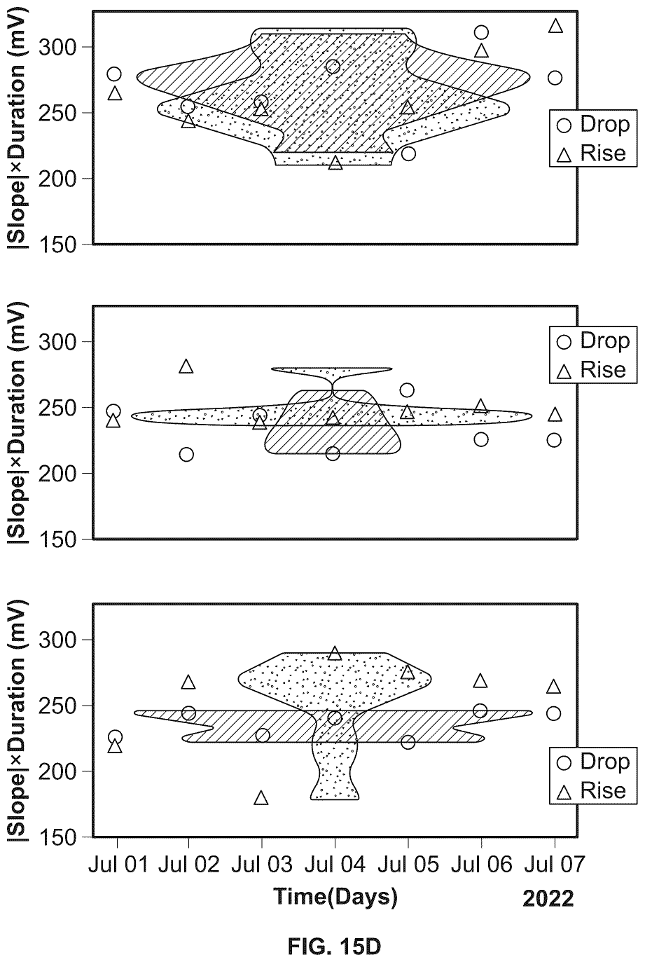

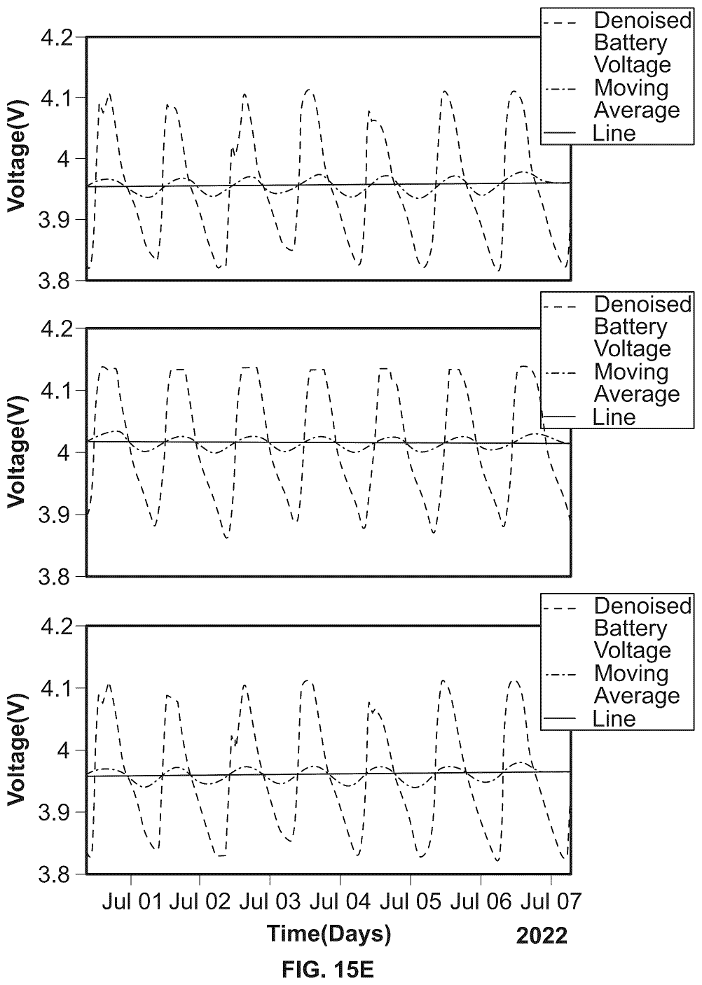

These minimum voltage levels exceed 3V, that is the discharge cutoff voltage of the sensor nodes' batteries in FIG. 2. Additionally, as it is shown in FIG. 15, the sonar voltage assessment during the first week of July demonstrates that s13, s18, and s19 have a minimum voltage of 3.82V, 3.88V, and 3.84V, respectively.

Therefore, the consumption of the sonar sensors does not cause the batteries to get lower than the cutoff voltage in the designed energy system in summer and fall, proving that the design fulfils the assessment criterion specified for the sustainability of the sensor nodes in this study. It should be noted that some batteries went off during the experiment, but the energy insufficiency was not the major reason. Table 5 provides a summary of the power evaluation results, illustrating the disparity between the drop and rise in battery voltage of the sensor node over the evaluation period.

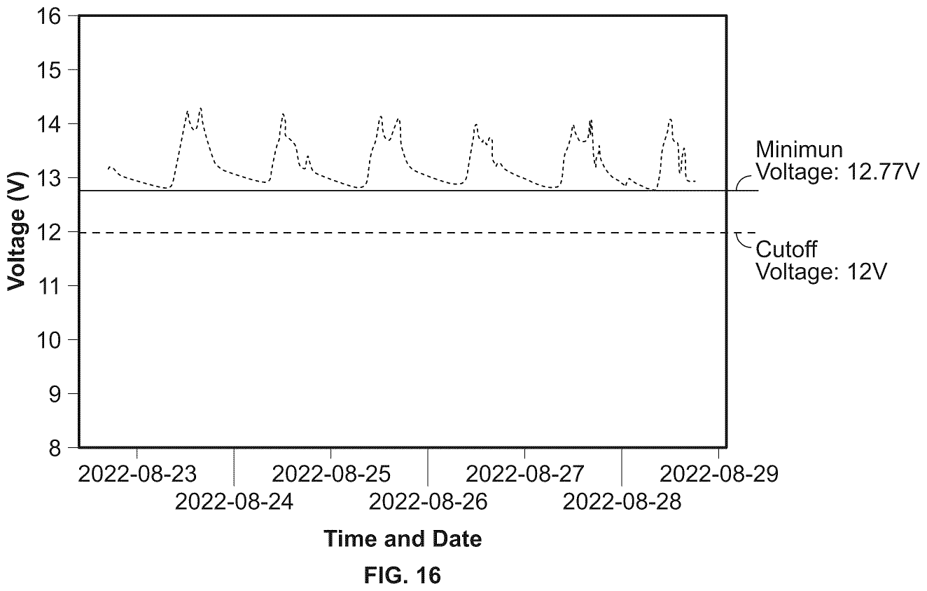

The table affirms that the voltage drops, and rises are closely aligned; however, it is noteworthy that, among the six evaluated sensors, the rise in voltage surpasses the voltage drop for five of them. 4.3. Voltage sufficiency in communication nodes FIG. 16 shows the variations in the voltage of the battery used to charge a hotspot from August 22 to Aug. 29, 2022.

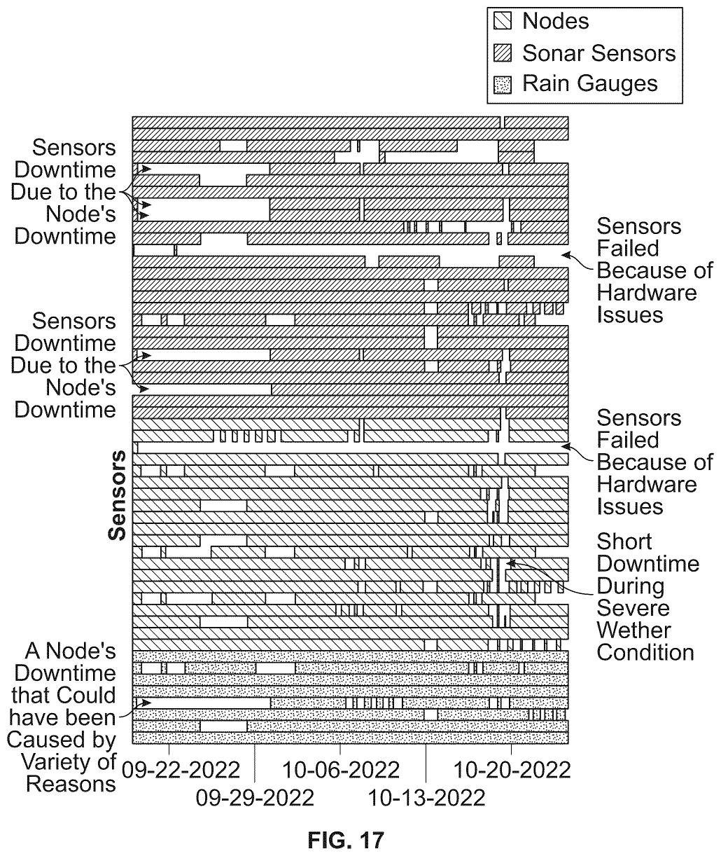

The measured voltage stands above the battery cutoff voltage by a margin. This margin, which is always equal or higher than 0.77V during this measurement offers a safety factor of 1.064 for the voltage of hotspot battery. Likewise, upon visual inspection of the voltage graph the voltage does not follow a downward trend. Accordingly, the design of the energy system of the communication nodes satisfies the voltage criterion imposed by the battery cutoff voltage. 4.4. Result summary FIG. 17 provides a summary of the experimental deployment of the rain and sonar sensors in the network from September 20th to Oct. 20, 2022, indicating their online and outage intervals.

TABLE 5
Summary of the evaluation results.

| | Rain | | | | | |
|---|---|---|---|---|---|---|
| | r4 | | r9 | | r18 | |
| | Voltage | Voltage | Voltage | Voltage | Voltage | Voltage |
| Day | Rise (mV) | Drop (mV) | Rise (mV) | Drop (mV) | Rise (mV) | Drop (mV) |
| June 30 | 312.23 | −324.8 | 287.48 | −262.22 | 208.53 | −224.09 |
| Jul 1 | 298.23 | −319.90 | 262.74 | −249.05 | 295.63 | −235.41 |
| Jul 2 | 269.74 | −278.00 | 260.76 | −273.33 | 238.44 | −233.73 |
| Jul 3 | 284.79 | −332.10 | 231.83 | −216.02 | 252.59 | −217.50 |
| Jul 4 | 354.20 | −287.70 | 295.80 | −301.41 | 287.34 | −271.47 |
| Jul 5 | 350.83 | −352.90 | 331.93 | −279.49 | 283.15 | −230.95 |
| Jul 6 | 356.43 | −314.30 | 322.51 | −251.49 | 269.34 | −239.36 |
| Sum | 2227 | −2210 | 1993 | −1833 | 1835 | −1653 |
| | Sonar | | | | | |
| | s13 | | s18 | | s19 | |
| | Voltage | Voltage | Voltage | Voltage | Voltage | Voltage |
| Day | Rise (mV) | Drop (mV) | Rise (mV) | Drop (mV) | Rise (mV) | Drop (mV) |
| June 30 | 260.98 | −277.59 | 234.90 | −244.26 | 214.51 | −220.55 |
| Jul 1 | 240.04 | −251.44 | 277.12 | −210.43 | 264.17 | −240.39 |
| Jul 2 | 248.39 | −255.90 | 232.58 | −240.77 | 172.88 | −222.98 |
| Jul 3 | 206.45 | −283.57 | 238.46 | −210.51 | 287.14 | −236.98 |
| Jul 4 | 251.43 | −214.92 | 242.73 | −259.99 | 272.49 | −218.23 |
| Jul 5 | 295.07 | −310.42 | 246.41 | −221.77 | 265.09 | −241.89 |
| Jul 6 | 313.96 | −275.13 | 240.31 | −221.17 | 260.78 | −240.82 |
| Sum | 1816 | −1869 | 1713 | −1609 | 1737 | −1622 |

The uptimes of sonar and rain sensors are represented by blue and green colors, respectively. Additionally, the node sensors including the communication nodes, plus a thermometer and a humidity sensor per each node are shown with red color in this figure. Moreover, the white areas represent the downtimes of the sensors, which are the failures in real-time data acquisition by the sensors caused by variety of reasons. The failures in communication nodes caused by different factors such as lack of network, hotspots' battery depletion, surpassing the allowable temperature range accounts for most of the downtimes of the sensors in the network. Additionally, hardware problems result in the permanent failure of some of the sensors. Severe weather conditions are another factor causing short- or long-term downtime of the sensors. Usually, these sensors automatically restore power and resume operations after heavy rains or strong winds. However, in some cases, maintenance is required to bring them back to full functionality. Most of the sensors in FIG. 17 are operational throughout the graph with occasional disruptions due to severe weather conditions and some maintenance issues. The rain and node sensors exhibit a higher level of reliability than the sonar sensors, which experiences more frequent downtime due to battery depletion and signal interference. Nevertheless, the network achieves a satisfactory operation in its level of coverage and sustainability in detecting precipitation and water level changes, demonstrating the potential of such sensor systems for monitoring environmental conditions and informing sustainable low-cost flood prediction strategies.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure. Also, to the above description, the materials attached hereto form part of the disclosure of this provisional patent application.

What is claimed is:

1. A data acquisition system comprising: a communication node and a sensor node; said communication node including a hotspot connected to a first battery which is connected to a first solar panel and a said sensor node including a plurality of sensors connected to a second battery which is in communication with a second solar panel.

2. The system of claim 1 wherein said hotspot receives power from said first solar panel when said first solar panel is producing sufficient electricity to operate said hotspot and said first battery is charged when said first solar panel is producing sufficient electricity to charge said battery.

3. The system of claim 2 wherein said hotspot receives power from said first battery when said first solar panel is not producing sufficient electricity to operate said hotspot.

4. The system of claim 3 wherein said plurality of sensors receive power from said second solar panel when said second solar panel is producing sufficient electricity to operate said plurality of sensors and said second battery is charged when said second solar panel is producing sufficient electricity to charge said second battery.

5. The system of claim 4 wherein said plurality of sensors receive power from said second battery when said second solar panel is not producing sufficient electricity to operate said plurality of sensors.

6. The system of claim 5 wherein said sensor node further includes a control device adapted to direct power from said second solar panel or second battery to said plurality of sensors.

7. The system of claim 6 further including a control device adapted to direct power from said first solar panel or first battery to said hotspot.

8. The system of claim 7 wherein said network of sensors include a plurality of sonar and rain sensors.
